(19) United States
(12) Patent Application Publication
(10) Pub. No.: US 2001/0016504 A1
(43) Pub. Date: Aug. 23, 2001

(54) METHOD AND SYSTEM FOR HANDLING RADIO SIGNALS IN A RADIO BASE STATION

(76) Inventors: HENRIK DAM, STOCKHOLM (SE); ULF FORSSEN, SALTSJO-BO (SE); SOREN ANDERSON, SOLLENTUNA (SE); JOHNNY WIDEN, MOLNDAL (SE); JONAS KARLSSON, YOKOHAMA (JP)

Correspondence Address: BURNS DOANE SWECKER & MATHIS L L P, POST OFFICE BOX 1404, ALEXANDRIA, VA, 22313-1404, US

(21) Appl. No.: 09/053,951

(22) Filed: Apr. 3, 1998

(51) Int. Cl. H04M 1/00; H04B 1/38

(52) U.S. Cl. 455/562; 455/78; 455/73; 455/272; 455/273; 455/276.1; 455/278.1; 455/422; 455/432; 455/436; 455/550; 455/560; 455/561

(57) ABSTRACT

A radiocommunication system is described wherein a flexible transceiver is provided that can be switchably connected to different antenna structures. Switching matrices are provided between the antenna elements and the receive processing circuitry which, under the control of the central processing unit, allows the transceiver to handle the different antenna structures. The enhanced flexibility achieved by the present invention provides a novel transceiver which can, for example, be reconfigured between and during calls to dynamically assign resources based upon changes in the amount and type of load being experienced by the system and adjusted in order to render existing operating functions more efficient.

### BACKGROUND

The present invention pertains to systems and methods involved in radiocommunication systems and, more particularly, to reconfigurable transceivers that can be readily used with different types of antenna arrangements and methods for using such transceivers.

The cellular telephone industry has made phenomenal strides in commercial operations in the United States as well as the rest of the world. Growth in major metropolitan areas has far exceeded expectations and is rapidly outstripping system capacity. If this trend continues, the effects of this industry's growth will soon reach even the smallest markets. Innovative solutions are required to meet these increasing capacity needs as well as maintain high quality service and avoid rising prices.

FIG. 1 illustrates an example of a conventional cellular radio communication system 100. The radio communication system 100 includes a plurality of radio base stations 170a-n connected to a plurality of corresponding antennas 130a-n. The radio base stations 170a-n in conjunction with the antennas 130a-n communicate with a plurality of mobile terminals (e.g. terminals 120a, 120b and 120m) within a plurality of cells 110a-n. Communication from a base station to a mobile terminal is referred to as the downlink, whereas communication from a mobile terminal to the base station is referred to as the uplink.

The base stations are connected to a mobile telephone switching office (MSC) 150. Among other tasks, the MSC coordinates the activities of the base stations, such as during the handoff of a mobile terminal from one cell to another. The MSC, in turn, can be connected to a public switched telephone network 160, which services various communication devices 180a, 180b and 180c.

A common problem that occurs in a cellular radio communication system is the loss of information in the uplink and downlink signals as a result of multi-path fading, which results when the transmitted signal travels along several paths between the base station and the intended receiver. When the differences in the path lengths between the base station and the mobile terminal are relatively small, the multiple signal images arrive at almost the same time. The images add either constructively or destructively, giving rise to fading, which can have a Rayleigh distribution. When the path lengths are relatively large, the transmission medium is considered time dispersive, and the added images can be viewed as echoes of the transmitted signal, giving rise to intersymbol interference (ISI).

Fading can be mitigated by using multiple receive antennas and employing some form of diversity combining, such as selective combining, equal gain combining, or maximal-ratio combining. Diversity takes advantage of the fact that the fading on the different antennas is not the same, so that when one antenna has a faded signal, chances are the other antenna does not. ISI multi-path time dispersion can be mitigated by some form of equalization, such as linear equalization, decision feedback equalization, or maximum likelihood sequence estimation (MLSE).

Interference can also degrade the signals transmitted between a base station and mobile terminals. For instance, a desired communication channel between a base station and a mobile terminal in a given cell can be degraded by the transmissions of other mobile terminals within the given cell or within neighboring cells. Other base stations or RF-propagating entities operating in the same frequency band can also create interference (e.g., through “co-channel” or “adjacent channel” interference in systems providing access using time division multiple access (TDMA) techniques).

Frequency re-use can be used to, among other things, mitigate interference by placing interfering cells as far from each other as possible. Power control can also be used to reduce the interference by ensuring that transmitters communicate at minimal effective levels of power. Such power control techniques are especially prevalent in code-division multiple access (CDMA) systems, due to the reception of information in a single frequency channel at each base station.

Interference can be reduced still further by using a plurality of directional antennas to communicate with mobile terminals within a cell. The directional antennas (also known as “sector antennas”) transmit and receive energy within a limited geographic region, and thereby reduce the interference experienced by those radio units outside the region. Typically, radio communication cells are partitioned into three 120° sectors serviced by three sector antennas, or six 60° sectors serviced by six sector antennas. Even smaller antenna sectors can be achieved using a fixed-beam phased array antenna, which transmits and receives signals using a plurality of relatively narrow beams. FIG. 2, for instance, illustrates such an exemplary radio communication system 200 including a radio base station 220 employing a fixed-beam phased array (not shown). The phased array generates a plurality of fixed narrow beams (B₁, B₂, B₃, B₄, etc.) which radially extend from the base station 220. Preferably, the beams overlap to create a contiguous coverage area to service a radio communication cell. Although not shown, the phased array can actually consist of three phased array sector antennas, each of which communicates with a 120° swath extending from the base station 220.

FIG. 2 shows a mobile terminal 210 located within the coverage of one of the beams, B₁. Communication proceeds between the base station 220 and this mobile terminal 210 using the beam B₁, or perhaps, in addition, one or more adjacent beams. The reader will appreciate that modern radio communication environments typically include many more mobile terminals within cells. Nevertheless, even when there are plural mobile terminals within a cell, a subset of the beams may not include any mobile terminal stations within their coverage. Hence, in conventional fixed-beam phased array systems, these beams remain essentially idle until a mobile terminal enters their assigned geographic region. Such idle beams propagate needless energy into the cell, and thus can contribute to the net interference experienced by radio units within the cell as well as other cells (particularly neighboring cells). These beams also add to the processing and power load imposed on the base station 220.

These concerns are partly ameliorated though the use of a variation of the above-discussed system, referred to as “adaptive” phased arrays. Such arrays allow for the selective transmission and reception of signals in a particular direction. For instance, as shown in FIG. 3, an array 300 can be used to receive a signal transmitted at an angle Θ (with respect to the normal of the array) from a target mobile terminal 380, and can simultaneously cancel the unwanted signals transmitted by another mobile terminal 370. This is accomplished by selecting (complex) weights (w₁, w₂, . . . wₙ) applied to each signal path (r₁, r₂, . . . rₙ) from the phase array antenna 300 so as to increase the sensitivity of the array in certain angular directions and reduce the sensitivity of the array in other directions (such as by steering a null toward an interference source). The desired weighting is selected by iteratively changing the weights through a feedback loop comprising beamforming unit 340, summer 330 and controller 320. The feedback loop functions to maximize signal-to-interference ratio at the output “x” of the beamforming unit. RF beamforming is an alternative way to obtain fixed beamforming. Application of an adaptive phased array antenna to the radio communication system shown in FIG. 1 would result in the generation of a single beam (or small subset of beams) generally oriented in the direction of the single mobile terminal 210. Such a system offers a substantial reduction in interference. For example, as disclosed in “Applications of CDMA in Wireless/Personal Communications” by Garg et al., Prentice Hall, 1997, an idealized eight-beam antenna could provide a threefold increase in network capacity when compared with existing schemes such as cell splitting (pp. 332-334). Moreover, the presence and location of mobile terminals in both the fixed and adaptive beamforming cellular radio communication systems can be determined by measuring the signal strength in the uplink direction on each beam. The beam direction yielding the strongest received signal can be used to indicate the probable location of the desired mobile.

As can be seen from the foregoing, there are many types of antenna arrangements which are used and/or contemplated for use with transceivers in radiocommunication systems. However, conventional transceivers are inflexibly designed for use with a particular antenna arrangement and diversity combining technique, e.g., some transceivers in use today are designed to work only with single antennas (no diversity), some transceivers are designed to work only with a pair of directional antennas with a specific type of diversity combining technique, while still other transceivers may be designed to work only with antenna arrays. Moreover, in the future, it is anticipated that additional techniques will be developed for processing the information available using multiple antennas or antenna array elements, e.g., new positioning techniques, new combining techniques, etc. and that additional, new antenna structures will be developed. Today, network operators that wish to make changes to their antenna arrangements face the daunting task of needing to replace their transceivers' hardware. For example, changes to the frequency plan or the antenna arrangement (i.e., from adaptative antenna arrays to sector antennas or vice versa) typically require expensive and time consuming hardware changes. In some cases, the expense associated with such hardware changes may make the desired improvements economically unfeasible.

It is therefore an exemplary objective of the present invention to provide transceivers which do not suffer from the above-described drawbacks. Moreover, having provided a more flexible transceiver design, another exemplary objective of the present invention is to take advantage of the flexibility in operation of the transceiver to more efficiently perform certain transceiver functions, e.g., locating of a mobile terminal during access to the system.

### SUMMARY

According to a first exemplary aspect of the present invention, the above objective is achieved by providing a transceiver unit having a flexible design which allows the transceiver unit to operate in conjunction with plural different types of antenna structures and information processing techniques. For example, switching matrices can be provided between the antenna arrangements and the receive processing circuitry which, under control of a central processing unit, allows the transceiver to handle different antenna structures. This flexibility can be invoked in a variety of ways. For example, a network operator can adjust the types of antenna structures connected to the transceiver in order to implement new frequency plans. Alternatively, the transceiver unit can be reconfigured between calls, or even during a call, to dynamically assign resources based upon changes in the amount and type of load being experienced by the system.

Moreover, other exemplary embodiments of the present invention take advantage of the flexibility of these novel transceiver units to render other operating functions more efficient. For example, decoding of an access burst on a random access channel can be performed in parallel with locating the remote terminal using a reduced number of radio processing circuits by selectively switching some of the radio processing circuits to each antenna beam of an array to perform the scanning (locating) function. The scanning frequency can be selected so that all of the beams are polled during the time in which an access burst is received on the sector antennas.

### BRIEF DESCRIPTION OF THE DRAWINGS

The foregoing objects, features and advantages of the present invention, as well as other features, will be more readily understood upon reading the following detailed description in conjunction with the drawings in which:

FIG. 1 shows a conventional radio communication system including plural base stations and a mobile telephone switching office;

FIG. 2 shows a conventional base station which uses a phased array with a fixed beamforming processor;

FIG. 3 shows a block diagram of a base station which uses a conventional adaptive phased array;

FIG. 4 shows a flexible base station transceiver which uses a phased antenna array with a fixed beamforming circuit and sector antennas according to exemplary aspects of the present invention;

FIG. 5(a) depicts an exemplary switching configuration for the transceiver of FIG. 4;

FIG. 5(b) depicts another exemplary switching configuration for the transceiver of FIG. 4;

FIG. 6 depicts radio receiver allocation to different remote stations over a plurality of timeslots according to exemplary embodiments of the present invention;

FIG. 7 illustrates a transceiver configured to perform parallel decoding and scanning according to an exemplary embodiment of the present invention;

FIG. 8 illustrates a timing relationship between access burst reception and scanning of antenna elements according to an exemplary embodiment of the present invention;

FIG. 9 is a flowchart illustrating parallel decoding and scanning according to an exemplary embodiment of the present invention; and

FIG. 10 illustrates a method of dividing the fixed narrow beams into two groups according to an exemplary embodiment of the present invention.

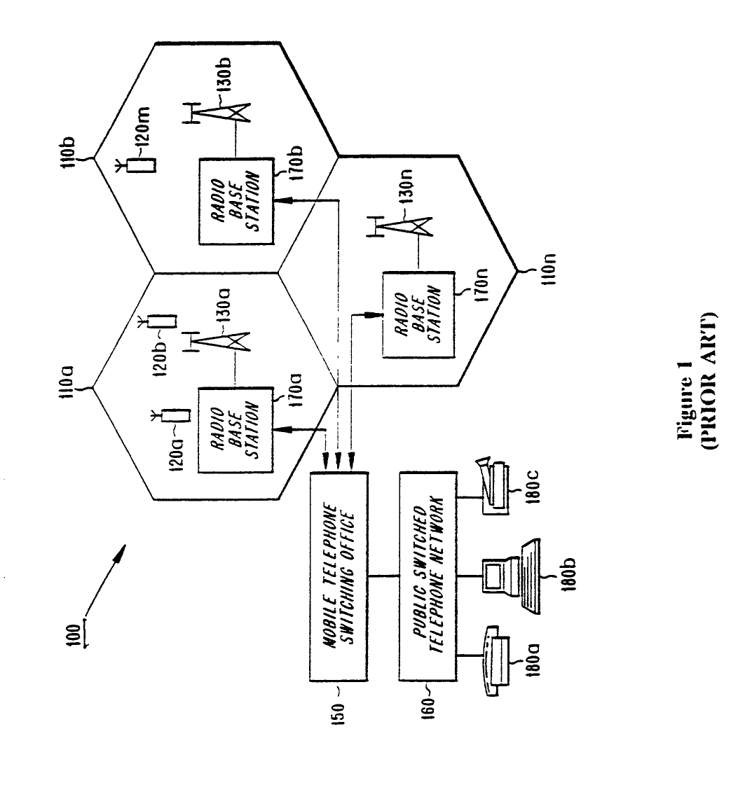

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

The exemplary radio communication systems discussed herein are described as using the time division multiple access (TDMA) protocol, in which communication between the base station and the mobile terminals is performed over a number of time slots. However, those skilled in the art will appreciate that the concepts disclosed herein find use in other protocols, including, but not limited to, frequency division multiple access (FDMA), code division multiple access (CDMA), or some hybrid of any of the above protocols. Likewise, some of the exemplary embodiments provide illustrative examples relating to the GSM system, however, the techniques described herein are equally applicable to radio base stations in any system.

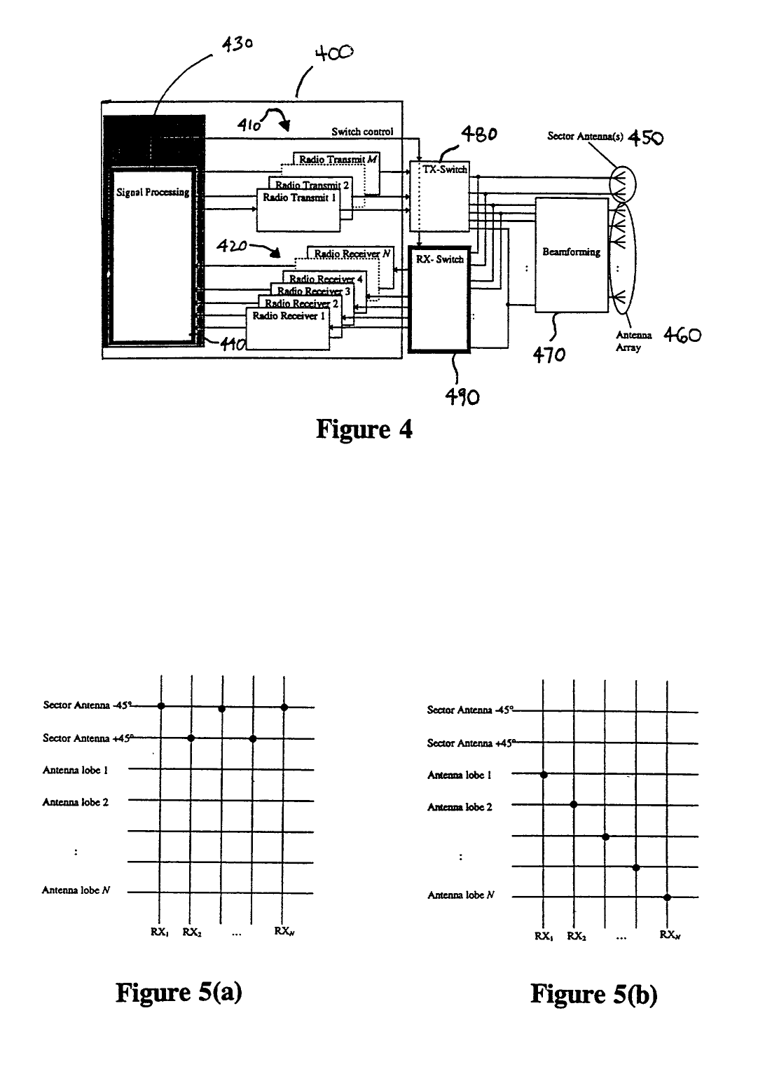

FIG. 4 illustrates a transceiver unit 400 according to an exemplary embodiment of the present invention which can be used, for example, in cellular base stations. Therein, a plurality of radio transmitters 410 and radio receivers 420 are provided, each of which is adapted to handle at any one time a particular carrier frequency. One skilled in the art would recognize that many radio receivers may handle the same carrier frequency. The radio transmitters and receivers can be designed according to well known techniques, e.g., transmitters 410 may include amplifiers, upconverters, filters, analog-to-digital converters, etc. and receivers 420 will include amplifiers, downconverters, filters, digital-to-analog converters, etc. These devices are controlled by, and pass information to and from, control unit 430 which includes a central processing unit (not shown), memory (not shown) and a signal processing device 440. Signal processing device 440 provides the necessary software functionality for processing both signals to be transmitted and signals that are received via transmitters 410 and receivers 420, respectively. For example, signal processing unit 440 can provide the signal encoding, modulation, scrambling and channel filtering functions, etc. which may be necessary depending upon the channel configuration (e.g., access methodology, bandwidth, etc.) as will be appreciated by those skilled in the art. Likewise, signal processing circuitry 440 can also perform channel filtering, demodulation, decoding and descrambling tasks on received signals.

The signal processing device 440 can be implemented, according to exemplary embodiments of the present invention, using a flexible ASIC approach which allows the signal processing functions to be selectively changed to accommodate the antenna arrangement and signal processing desired by the network operator. As will be described more fully below, these types of changes in configuration may be made very rapidly, e.g., for every timeslot in the air interface frame structure, or only periodically, e.g., if the network operator decides to add a new antenna structure.

The transceiver unit 400 may have any number and type of antenna arrangement connected thereto. However, for the purposes of illustrating the present invention, transceiver unit 400 is connected to two directional sector antennas 450 and an antenna array 460 for N antenna lobes. As is well understood in the art, an antenna array has a number of elements, sometimes called partial antennas, which may be different in number than the number of antenna lobes that are produced. Antenna lobes are often formed by a beamforming unit which translates signals from many antenna elements into lobes, or vice-versa, using complex weight factors as is illustrated in FIG. 3. In some instances, the antenna lobes are formed by the signal processing device which, through the use of software, performs the same function as the beamforming unit by communicating directly with the elements of the antenna.

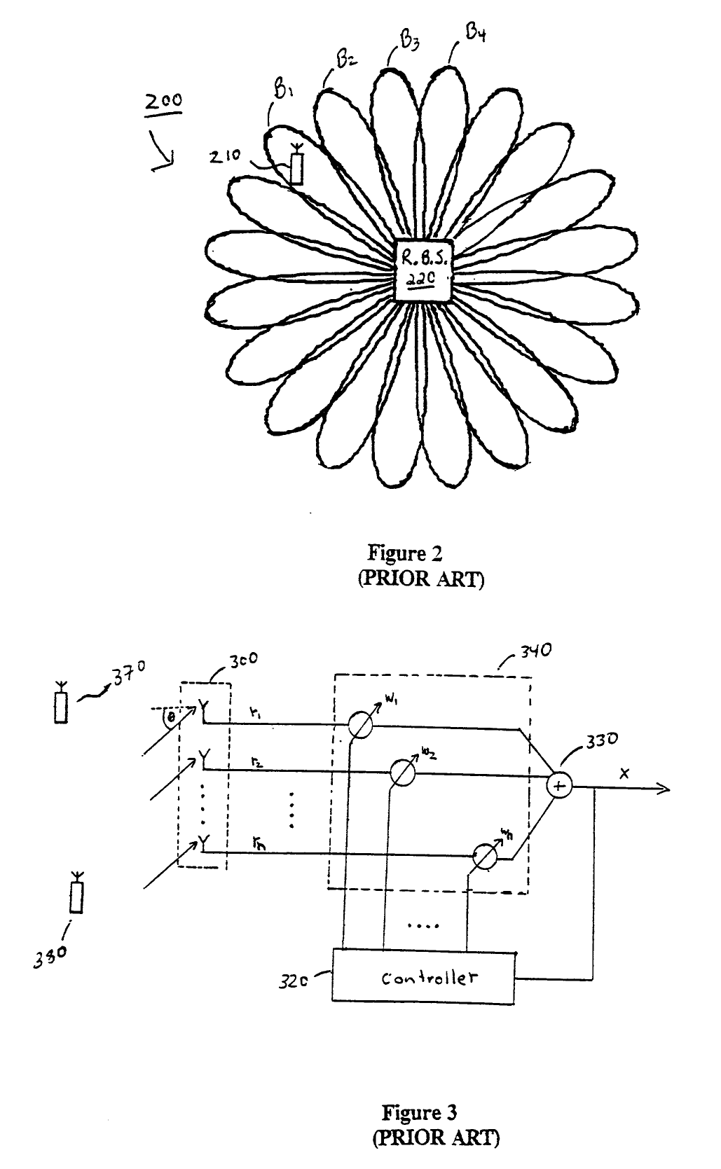

In FIG. 4, the antenna array 460 is supported by beamforming unit 470, which shapes and steers the plurality of beams to achieve a desired coverage area, such as to achieve the fixed beam configuration shown in FIG. 2. The beamforming unit 470 can comprise any conventional fixed beamformer, such as a Butler matrix. As illustrated in FIG. 4, each of the sector antennas 450 and each element of the antenna array 460 can be connected to one or more respective radio transmitter(s) 410 and radio receiver(s) 420 through transmit switch 480 and receive switch 490, respectively. The switches 480 and 490 are used by the transceiver unit 400 to selectively assign resources to various connections under the supervision of control unit 430. This aspect of the present invention provides a significant amount of flexibility, as compared with conventional transceivers wherein a transmitter and receiver chain were typically hardwired to an antenna, which flexibility is exploited as described below to improve efficiency and system capacity.

Using switches 480 and 490, the transceiver unit 400 is readily reconfigurable as illustrated in FIGS. 5(a) and 5(b). FIG. 5(a) illustrates an example wherein the receive switch matrix 490 is configured for connections between radio receivers 420 and the sector antennas to provide service on multiple carriers. Alternatively, FIG. 5(b) illustrates an example wherein the receive switch matrix 490 is configured such that each radio receiver 420 is connected to a respective array antenna lobe, for one carrier service. The ability to reconfigure transceivers according to the present invention in this manner provides significant improvements in flexibility and compatibility in system hardware not found in conventional radio base stations. In addition to the switches 480 and 490, control unit 430 includes a flexible ASIC which permits the re-use of receive and transmit hardware despite the connection of different antenna arrangements.

By allowing the antenna structures to be interchangeably connected to the transceiver unit, the present invention provides the network operator with numerous opportunities to optimize utilization of existing hardware resources. For example, flexible reconfiguration can be taken advantage of during installation of the transceiver unit. If being used as a common “macro” cell base station, the flexible transceiver of the present invention might be configured to use only an adaptive array antenna, which provides for higher spectral efficiency than sector antennas. On the other hand, if being used in an indoor (e.g., picocell) application, then the flexible transceiver may be connected to a plurality of distributed antennas. For example, one antenna may be positioned in a corridor of a building, which antenna is switched through a single radio transmitter 410 and a single radio receiver 420. In this latter example, if users are moving around in the building, then receiver diversity can easily be obtained by routing two of the distributed antennas through the same radio receiver 420 using receive switch 490. Likewise, transmit diversity can be obtained by transmitting the same signal from two (or more) of the distributed antennas by connecting a radio transmitter 410 to the two best antennas using switch 480. These are merely some of the examples of how a single type of transceiver unit according to the present invention can be used in multiple different applications.

Moreover, the flexibility afforded the network operator also extends beyond installation. Transceivers according to the present invention can also be reconfigured between calls or even during a connection between the transceiver and a mobile terminal.

One such potential for reconfiguration of transceivers according to the present invention exists where a network operator is able to recognize periodic changes in system load and adaptively reconfigure the transceiver to efficiently accommodate such changes. For example, consider areas where communication coverage is provided both by cellular systems and radio in the local loop (RLL) systems. As will be well known to those skilled in the art, RLL systems are hybrid wired and wireless systems wherein a portion of the conventional wired system is replaced by a radio interface. For example, in areas where population density is low, RLL systems may be provided where the radio interface is used to replace the typical wired connection between a telephone in a home and the network (PSTN).

In areas where both cellular and RLL coverage is desired, flexible transceivers according to the present invention provide network operators with a means to dynamically reassign resources to provide greater capacity. For example, consider a flexible transceiver as described above connected to an antenna array. During the day, when most subscribers are mobile, i.e., using the cellular system, the spatial filtering required for moving terminals can be achieved by configuring the flexible transceiver to connect each radio receiver 420 to one of the beams of the antenna array 460 to support communication over a single carrier frequency. In the evening, when most subscribers are at home using RLL terminals, a network operator can take advantage of the substantially fixed nature of RLL terminals to reconfigure the flexible transceiver such that only one or two of the radio receivers 420 are assigned to each carrier frequency. In this way, more communication links can be provided by the flexible transceiver when operating in an RLL mode than would otherwise be possible absent reconfiguration according to the present invention.

In addition to providing the flexibility to configure the transceiver at installation and reconfigure the transceiver between connections, exemplary embodiments of the present invention also provide techniques for reconfiguring the transceiver during a connection between a remote terminal and the base station. For example, the flexible transceiver may, taking into account current system load and estimating a risk for call blocking, assign a first number (e.g., 8) of radio receivers 420 and a second number of radio transmitters 410 (e.g., 4) to handle a connection between itself and a mobile station. During an initial period of time after the connection has been established, the flexible transceiver can use the information from the relatively large number of radio receivers to aid in rapidly and precisely estimating a location of the mobile terminal. Then, the flexible transceiver can adjust the assignment of radio receivers 420 and radio transmitters 410 so that fewer units (e.g., 2 radio receivers and 1 radio transmitter) are used to support the same connection, since the base station now has a reasonable estimate of the mobile terminal's location and can thus select appropriate beams for transmission and reception of data. In this way, the radio receivers 420 and radio transmitters 410 can be released for reassignment to support connections with other mobile terminals.

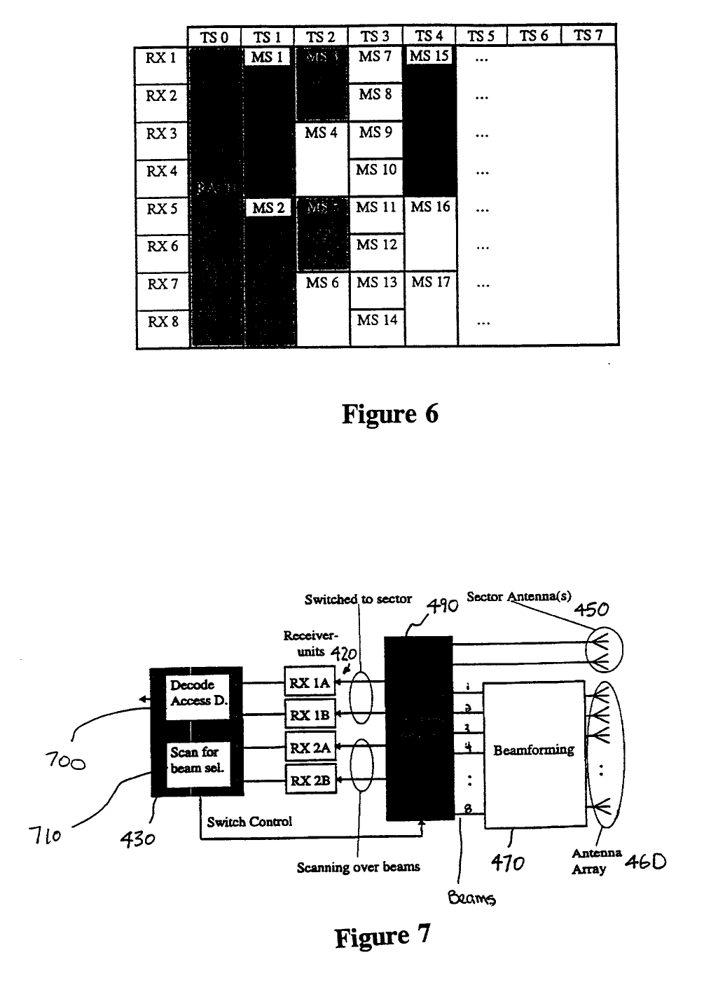

It will be apparent to those skilled in the art that the flexible transceiver according to the present invention can be configured and reconfigured in numerous ways to optimize radiocommunication service and reduce hardware costs. The table illustrated as FIG. 6 summarizes some of the possible configuration options. Along the vertical axis of the table, each of the exemplary eight radio receivers 420 available in the flexible transceiver are listed, while along the horizontal axis, each of eight timeslots are identified. The assignment of each radio receiver 420 during each timeslot is indicated within the table.

Therein, during a first timeslot (TSO), all eight of the radio receivers are assigned by the base station to support communications over the random access channel (RACH). As will be appreciated by those skilled in the art, the introduction of new mobile terminals into the cell (or the initiation of new calls within the boundaries of a cell) can be determined by detecting the presence of transmissions on the RACH by the new mobile terminals, which channel is used by the mobiles to request access to the system. A mobile unit desiring access sends a short access burst on the RACH to the base station. The network controller receives this information from the base station and assigns an idle voice channel to the mobile station, and transmits the channel identification to the mobile terminal through the base station so that the mobile terminal can tune itself to the new channel. Given the problem of locating the mobile, this exemplary embodiment assigns all available radio receivers 420 during the RACH timeslot to support this function According to another exemplary embodiment of the present invention, described in detail below, the flexibility of transceivers according to the present invention can be used to perform parallel scanning and decoding of RACH messages using fewer radio receivers.

During the next timeslot (TS1), two mobile terminals are supported by the flexible transceiver. Specifically, mobile MS1 is received by connecting four of the radio receivers 420 to antenna beams in the direction of MS1, while mobile MS2 is received by connecting four of the radio receivers 420 to antenna beams in the direction of MS2. TS2 illustrates another possibility wherein each of four mobile terminals MS3-MS6 are supported by two radio receivers 420. This may occur when, for example, sector antennas are being connected to the radio receivers and standard receive diversity is employed. Alternatively, this configuration may be employed when the flexible transceiver is configured for operation with adaptive antenna elements if the mobile terminals have been connected for a sufficient period of time that sufficient link quality and tracking can be achieved using two narrow beams.

In timeslot TS3, only one radio receiver 420 is used for each connection. This illustrates a possible configuration of the flexible transceiver when operating, for example, in the RLL mode described above wherein diversity gain is negligible due to the relatively immovable nature of RLL terminals. Timeslot TS4 depicts a mixture of the radio receiver assignment schemes of timeslots TS1 and TS2, to convey that combinations of different service support is also possible using the flexible transceiver according to the present invention.

The flexibility associated with transceivers according to the present invention, provides opportunities for a reduction in the amount of hardware needed to perform certain functions. For example, when employing antenna arrays with the transceiver, it is desirable to quickly and accurately estimate a location of the remote terminal when it requests system access. This location estimate is used to identify which of the narrow beams supported by the antenna array should be used to support the connection. Conventionally, location estimation using array antennas has been performed by fixedly connecting each beam in the array to its own, dedicated radio receiver. Then, when a remote terminal transmits to the transceiver, e.g., sends an access burst on the RACH, one or more characteristics associated with that burst, e.g., signal strength, can be determined for each beam. At the same time, the access burst can be decoded in one or more of the radio receivers to obtain the information transmitted therein. As will be apparent to those skilled in the art, any of the known direction-of-arrival (DOA) algorithms can then be used to estimate the remote terminal's location and select an appropriate beam or beams for handling the traffic channel.

However, this approach has the drawback that it requires a dedicated radio receiver for each antenna beam. As the number of antenna beams increases, so too does the size, cost and complexity of the transceiver unit.

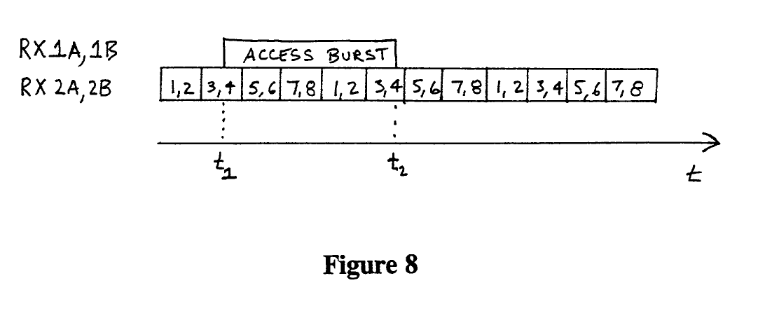

Using the flexible transceiver described in the foregoing exemplary embodiments, the number of radio receivers needed to scan for a remote terminal's location can be reduced. Consider the exemplary transceiver illustrated in FIG. 7 operating in a GSM system. Therein, like reference numerals have been used to refer to like elements described above with respect to FIG. 4. This exemplary transceiver has four radio receivers 420 which are used to both receive and decode the access burst and to scan for a plurality of beams for the remote terminals location. To accomplish these objectives in parallel, two of the radio receivers 420 (i.e., RX1A and 1B) have been selectively switched by control unit 430 via antenna switch 490 to be connected with a respective sector antenna 450. These receivers will process the received signal for decoding by unit 700 of control unit 430 to obtain the information in the access burst transmitted by the remote terminal on the RACH. The other two radio receivers 420 (i.e., RX2A and 2B) are each sequentially connected to a subset of the antenna elements via switch 490 to scan the beams associated with the antenna array 460 as coordinated by control unit 430. More specifically, for an exemplary eight beam array, during a first time period radio receivers RX2A and 2B will be connected to beams 1 and 2, during a second time period radio receivers RX2A and 2B will be connected to beams 3 and 4, during a third time period radio receivers RX2A and 2B will be connected to beams 5 and 6 and during a fourth time period radio receivers RX2A and 2B will be connected to beams 7 and 8. This sequence is then repeated such that these two radio receivers periodically poll each antenna as illustrated in FIG. 8.

During the time period when a radio receiver is connected to an antenna beam, the receiver processes the received signal to extract (or enable beam selection unit 710 to extract) one or more characteristics of the signal. The characteristic or characteristics will then be stored in a buffer, i.e., a memory device (not shown), for subsequent evaluation by the beam selection unit 710 as described below. After buffering the specified characteristic(s), the radio receiver is then switched to the next antenna beam in its designated sequence.

Due to the nature of radio propagation, the access burst transmitted by the remote terminal will arrive at the transceiver with some delay relative to the RACH frame structure, which delay is commonly referred to as access delay. Thus, reception of the access burst may not coincide with the beginning of the scanning sequence of those radio receivers which are assigned for iterative connection to the beams of the antenna array. This possibility is also reflected in FIG. 8, wherein the access burst is illustrated as being received at time t₁, which occurs during the time period when the radio receivers RX2A and 2B are connected to antenna elements 3 and 4. However, the length of the time period during which a radio receiver is connected to an antenna element is selected so that regardless of when an access burst is received, all of the antenna beams will be polled before the access burst has ended.

The access delay is determined by the transceiver, e.g., by recognizing a synchronization word transmitted in the access burst, and stored for use in decoding. Moreover, the access delay is also used in the present invention for retrieving the appropriate characteristics from the buffer to determine which beam should be selected for use in supporting the traffic channel. Thus, the beam selection unit 710 receives the access delay from decoding unit 700 and uses this information to select the buffered characteristics that were stored based on signals received on antenna beams 1-8 during the time t₁to t₂. Then, beam selection unit 710 applies its DOA algorithm to the retrieved characteristics to identify the appropriate beam(s) for subsequent communication support.

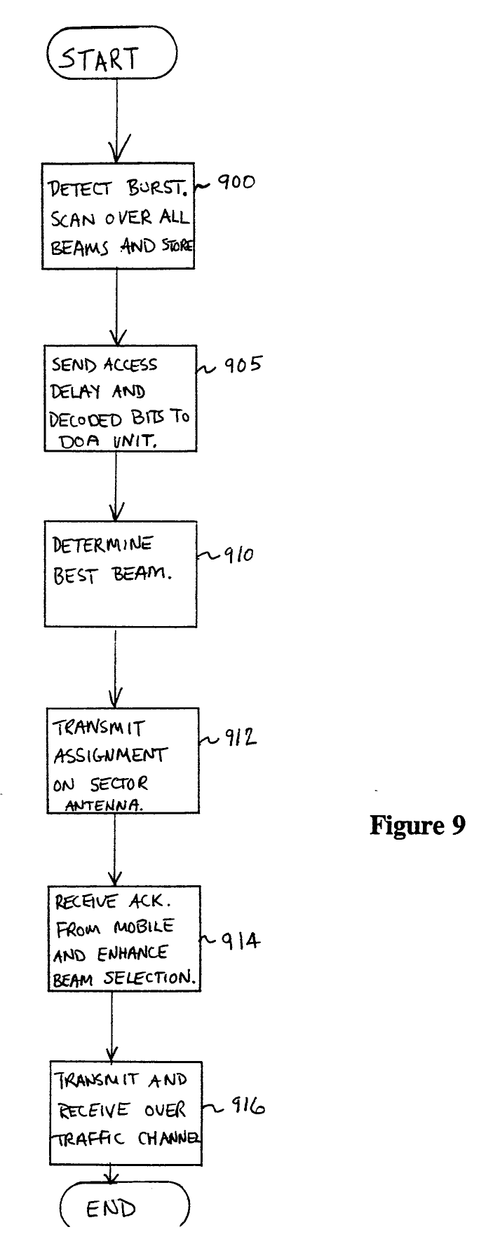

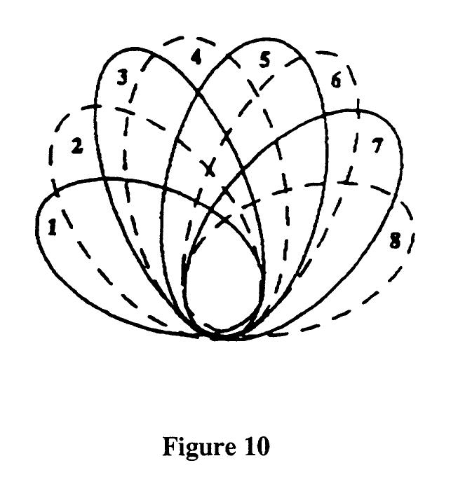

The method associated with this exemplary embodiment of the present invention is illustrated in the flowchart of FIG. 9. This method is characterized in terms of its operation in a GSM system, however those skilled in the art will appreciate that it can be applied to any system. The process begins at block 900 wherein the remote terminal transmits its access burst. In GSM, this access burst is transmitted over the RACH on a beacon frequency. The access burst is received on the sector antennas, and are decoded. At the same time, the beams of the antenna are scanned and stored in the buffer. Next, at block 905, the decoding function provides the access delay, as well as the decoded bits, to the DOA algorithm. Then, the DOA algorithm is used to identify a best beam, i.e., one which points most accurately toward the remote terminal, at block 910. As mentioned above, this involves retrieving the correct beam scanning information from the buffer using the access delay. The transceiver then transmits a traffic channel assignment to the remote terminal at block 912, which returns an acknowledgment message. Reception of the acknowledgment at step 914 can also be used to further enhance the beam selection of step 910 by scanning the antenna array and sending additional data regarding the evaluated characteristic(s) to the DOA algorithm. Finally, the connection switches to the traffic channel at step 916, e.g., by employing a narrow beam in the downlink and four radio receivers in the uplink to perform a tracking procedure.

The foregoing exemplary embodiment describes a technique for performing decoding and scanning in parallel at call set-up. However, similar techniques can be applied at handoff as well. The primary differences stemming from the fact that handoff signalling is performed over the traffic channel, since the remote terminal is in the midst of a connection, rather than a control channel or beacon frequency, as in the case of call set-up. This means that the new base station, i.e., the base station which will support the connection after the handoff, must decode the handoff signals transmitted by the remote terminal on its sector antennas so that the beams of its antenna array can be simultaneously scanned to estimate the position of the remote terminal. For example, the new base station can decode and combine the handoff signals from the remote terminal over a window of four TDMA frames, which corresponds to the amount of time two radio receivers would need to scan the antenna array for the entire sector.

However, requiring a transceiver to decode the handoff signalling on the traffic channel using its sector antennas requires more signal gain than is typically available, e.g., in systems designed in accordance with GSM. Thus, according to exemplary embodiments of the present invention, the remote terminal can be instructed (or preprogrammed) to transmit the first few handoff access bursts with increased power (e.g., 6dB) to compensate for the narrow beam antenna gain.

In another alternative embodiment, narrow beams may be used for both receiving an access burst at handover and determining the direction of the mobile. As illustrated in FIG. 10, the narrow beams are divided into two groups, i.e, beams 1, 3, 5 and 7 and beams 2, 4, 6 and 8. The base station first receives beams 1, 3, 5 and 7 in a first timeslot and beams 2, 4, 6 and 8 in the next timeslot. Since handover access bursts are repeated, the full antenna gain of the antenna array may be obtained by combining the results from two or more consecutive bursts.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims.

What is claimed is:

1. A base station for communication with at least one mobile terminal, said base station comprising:
an antenna arrangement for receiving a signal from said at least one mobile terminal, said antenna arrangement being of either a first or a second type;
receive processing circuitry for performing a first set of signal processing tasks on said signal; and
a processor for performing a second set of signal processing tasks, said second set of signal processing tasks being selected by said processor based upon whether said antenna arrangement is of said first or said second type.

2. The base station of claim 1, wherein said antenna arrangement further comprises a plurality of antenna elements, said receive processing circuitry further comprises a plurality of receive processing elements and said base station further comprises:
a switching unit for selectively coupling at least one of said plurality of antenna elements to one of said plurality of receive processing elements based on a control signal from said processor.

3. The base station of claim 2, further comprising a beamforming unit which connects said plurality of antenna elements and said switching unit.

4. The base station of claim 1, wherein said first type of antenna arrangement is a plurality of sector antennas and said second type of antenna arrangement is an antenna array.

5. The base station of claim 2, wherein said first type of antenna arrangement is a plurality of sector antennas and said second type of antenna arrangement is an antenna array.

6. The base station of claim 3, wherein said first type of antenna arrangement is a plurality of sector antennas and said second type of antenna arrangement is an antenna array.

7. The base station of claim 1, wherein said first set of signal processing tasks includes radio frequency downconverting.

8. The base station of claim 2, wherein said first set of signal processing tasks includes radio frequency downconverting.

9. The base station of claim 3, wherein said first set of signal processing tasks includes radio frequency downconverting.

10. The base station of claim 1, wherein said second set of signal processing tasks includes channel filtering, demodulation and decoding.

11. A method for reconfiguring a base station in a radiocommunication system comprising the steps of:
providing said base station with a plurality of receive processing circuits and a plurality of transmit processing circuits;
initially assigning a first number of said plurality of receive processing circuits to handle signals received from a remote station and a second number of said plurality of transmit processing circuits to handle the transmission of signals by said base station to said remote station;
processing said received signals using said first number of said plurality of receive processing circuits and said transmitted signals using said second number of said plurality of transmit processing circuits;
changing said assignments such that a third number of said receive processing circuits handles signals received from said remote station and a fourth number of said plurality of transmit processing circuits handle the transmission of signals by said base station to said remote station; and
subsequently processing said received signals using said third number of said plurality of receive processing circuits and said transmitted signals using said fourth number of said plurality of transmit processing circuits.

12. The method of claim 11, wherein said step of changing said assignments occurs during a connection between said base station and said remote station.

13. The method of claim 12, wherein said step of processing further comprises estimating a location of said remote station.

14. The method of claim 12, wherein said first number is greater than said third number and said second number is greater than said fourth number.

15. The method of claim 12, wherein said step of changing assignments occurs in response to a change in traffic load supported by said base station.

16. The method of claim 11, wherein said step of changing said assignments occurs between connections.

17. A base station comprising:
a plurality of receive processing circuits;
a plurality of transmit processing circuits;
a plurality of antenna elements;
switching means for selectively connecting receive processing circuits to antenna elements and transmit processing circuits to antenna elements; and
a control unit for sending control signals to said switching means, wherein said control unit initially assigns a first number of receive processing circuits and a second number of transmit processing circuits to a first radio connection supported by said base station and subsequently assigns a third number of receive processing circuits and a fourth number of transmit processing circuits to a second connection.

18. The base station of claim 17, wherein said first and second radio connection are the same connection.

19. The base station of claim 18, wherein said first number is greater than said third number, wherein said base station can estimate a location of a remote station associated with said first connection.

20. The base station of claim 19, wherein said control unit sends control signals to said switching means to connect said fourth number of transmit processing circuits to antenna elements based on said estimated location.

21. The base station of claim 17, wherein said control unit makes said subsequent assignments based upon a change in system load.

22. The base station of claim 17, wherein said control unit makes said initial assignment

23. A method for estimating a location of a remote terminal in a radiocommunication system comprising the steps of:
(a) receiving a transmission from said remote terminal on each of a plurality of antenna elements;
(b) connecting a radio signal processing unit to at least one of said plurality of antenna elements to generate a characteristic of said received transmission associated with said at least one of said plurality of antenna elements;
(c) buffering said characteristic; and
(d) switching said radio signal processing unit such that said radio signal processing unit is connected to another at least one of said plurality of antenna elements to generate said characteristic for said received transmission associated with said another at least one of said plurality of antenna elements.

24. The method of clam 23, wherein said plurality of antenna elements consist of distributed antennas.

25. The method of claim 23, wherein said plurality of antenna elements are part of an antenna array,
said radio signal processing unit is connected to said plurality of antenna elements through a beamforming unit, and
wherein said characteristic is a characteristic of a beam.

26. A method for decoding and scanning in a radiocommunication system comprising the steps of:
receiving a burst from a remote terminal on at least one sector antenna;
decoding said burst to obtain decoded data;
receiving said same burst on a plurality of antenna beams associated with an array;
iteratively connecting a radio receiver to said plurality of antenna beams during a time period while said burst is being received, wherein a characteristic associated with said burst can be determined for each of said plurality of antenna beams; and
using said measured characteristic to form an estimate of said remote terminal's location.
